(19) United States
(12) Patent Application Publication
(10) Pub. No.: US 2007/0081812 A1
(43) Pub. Date: Apr. 12, 2007

(54) Camera apparatus having a moving image playback function in multiple image selection screen

(75) Inventors: Tatsuhiko Ikehata, Ome-shi (JP); Tatsuro Abe, Ome-shi (JP); Kei Tashiro, Ome-shi (JP); Toyokazu Aizawa, Sagamihara-shi (JP); Tsuyoshi Hagiwara, Ome-shi (JP); Shiro Nagaoka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/394,230

(22) Filed: Mar. 31, 2006

(30) Foreign Application Priority Data
Mar. 31, 2005 (JP) 2005-104425

(51) Int. Cl. G03B 17/18

(52) U.S. Cl. 396/287

(57) ABSTRACT

An embodiment of a camera apparatus includes an image display control unit, which displays a moving image in a reduced state while displaying multiple reduced images in a display unit for displaying images held in a recording unit having an image file, when a moving image is included in the multiple reduced images and playback of the moving image is selected. This permits playing a moving image continuously in a reduced state, when the moving image is included in multiple reduced images.

### CROSS-REFERENCE TO RELATED APPLICATIONS

This application is based upon and claims the benefit of priority from Japanese Patent Application No. 2005-104425, filed Mar. 31, 2005, the entire contents of which are incorporated herein by reference.

### BACKGROUND

1. Field

One embodiment of the invention relates to a camera apparatus, which can display multiple reduced images and select a desired image regardless of whether it is a still image or a moving image, when playing still and moving images taken by the camera apparatus.

2. Description of the Related Art

A camera apparatus, particularly an electronic camera apparatus that, unlike a conventional camera, uses no film, can record still and moving images in a recording medium, such as a semiconductor memory (a memory card) and a hard disc unit.

A captured image is displayed (played back) on a liquid crystal display provided integrally with the camera apparatus, a display unit capable of displaying a video signal, that is, a display unit used in a personal computer, or an ordinary television set, by the user by operating the camera apparatus.

As the capacity of a recording medium, such as a semiconductor memory and a hard disk unit has been increased and the cost has been decreased in recent years, a number of images (still images) can be recorded and a number of titles or long-duration of moving image can be recorded (saved).

It has been proposed to generate reduced images corresponding to each of the recorded images (still images) and titles (moving images), display the reduced images as a list, and facilitate selection of an image the user wants to display, when playing an image.

Japanese Patent Application Publication (KOKAI) No. 2002-112079 proposes dividing a display area to display images taken in continuous-exposure mode, and displaying multiple images, and displaying that the multiple images are taken in continuous-exposure mode, when a still image taken in continuous-exposure mode is included when displaying multiple images as reduced images.

However, according to the Publication 2002-112079, a desired image can be selected from multiple images displayed as reduced images, but for a moving image, a desired image must be selected and displayed as a series of images in ordinary play mode.

Namely, when an image selected from multiple images displayed as reduced images is a moving image, it is necessary to play that image once in ordinary play mode. This may impair retrievability. At present, there is no camera apparatus capable of playing a moving image in a reduced state.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are exemplary diagrams each shows an example of a camera apparatus capable of recording still and moving images and sound, according to an embodiment of the invention;

FIG. 2 is an exemplary diagram showing a control system of the camera apparatus according to an embodiment of the invention shown in the FIGS. 1A and 1B;

FIGS. 3A to 3C are exemplary diagrams each shows an example of an input (operation) procedure to display multiple reduced images in the camera apparatus according to an embodiment of the invention;

FIG. 4 is an exemplary diagram showing an example of an input (operation) procedure to play an optional moving image in a reduced state from the state displaying multiple reduced images in the camera apparatus shown in FIGS. 1A, 1B and 2, according to an embodiment of the invention;

FIG. 5 is an exemplary flowchart showing an example of the operation of a control system to play an optional moving image in a reduced state from the state displaying multiple reduced images shown in FIG. 4; and

FIG. 6 is an exemplary diagram showing an example of a signal processing system to play an optional moving image in a reduced state from the state displaying multiple reduced images shown in FIG. 4, according to an embodiment of the invention.

### DETAILED DESCRIPTION

Various embodiments according to the invention will be described hereinafter with reference to the accompanying drawings. In general, according to one embodiment of the invention, a camera apparatus includes an image display control unit, which displays a moving image in a reduced state while displaying multiple reduced images in a display unit for displaying images held in a recording unit having an image file, when a moving image is included in the multiple reduced images and playback of the moving image is selected.

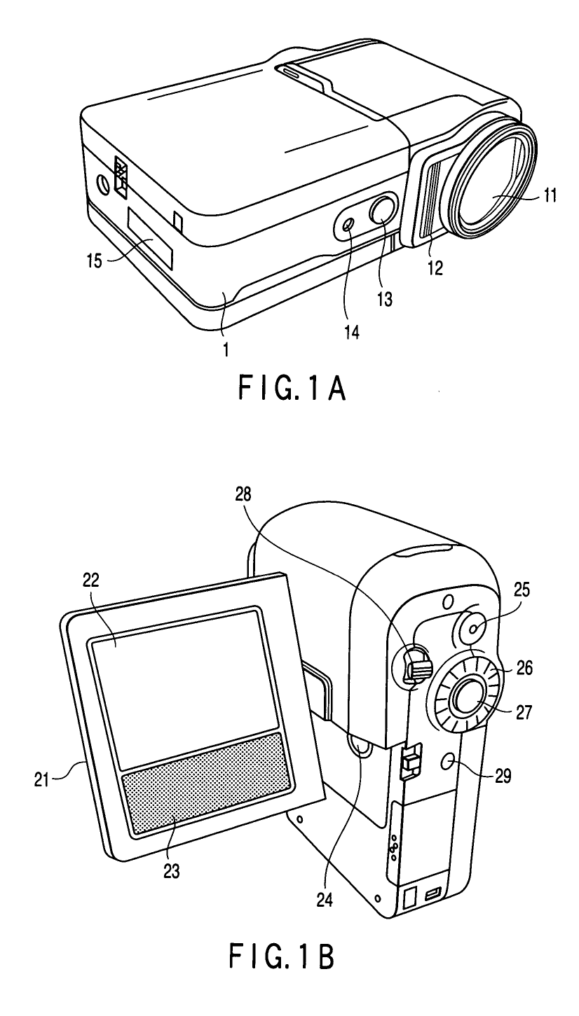

FIGS. 1A and 1B show schematic illustrations of an electronic camera apparatus capable of recording still and moving images and sounds, to which an embodiment of the present invention is applicable.

FIG. 1A shows a camera apparatus (an image pickup apparatus) 1 viewed from the camera lens side. The electronic camera apparatus 1 has a camera lens 11, a flash 12, a shutter button 13 (for a still image), and a remote control receiver 14. The camera apparatus 1 also has an adapter connector (a connection terminal) 15 used for connection with a personal computer and an external power supply (a charger).

FIG. 1B shows the electronic camera apparatus 1 viewed from the opposite side of the camera lens 11.

The camera apparatus 1 has a liquid crystal monitor (LCD panel) 22 and a speaker 23 provided integrally with a frame 21 functioning also as a main power switch. The electronic camera apparatus 1 also has a main power switch 24 at a fixed position, which is turned off at the position where the frame 21 is closed (housed at a fixed position of the main body of the electronic camera).

The electronic camera apparatus 1 has, at predetermined positions, a record button 25 capable of inputting instructions (commands) to start and stop recording a moving image, a jog (JOG) dial 26 capable of inputting instructions (control commands) to input operation modes and conditions and select decisions, a set (OK) button 27 capable of inputting an instruction (a control command) to determine (execute) the instruction selected (guided) by the jog dial 26, a zoom bar 28 capable of inputting a control signal for zoom operation to change the angle of an image (the angle to take a picture of a subject) to be taken by the camera lens 11, and a menu button 29 used to input a control command to display a menu screen.

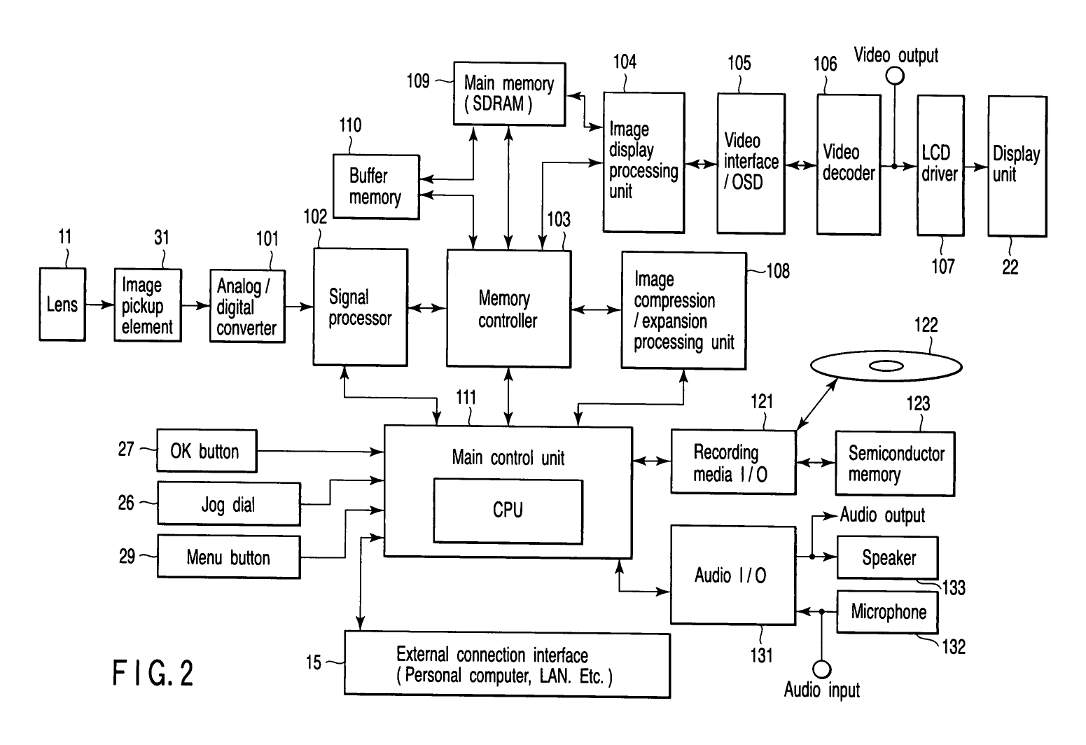

FIG. 2 shows an example of a control system of the camera apparatus shown schematically in FIGS. 1A and 1B.

A subject image taken by the camera lens 11 is focused on an image forming plane of the image pickup element 31, or a CCD sensor, for example, and converted to an analog signal (taken image data). The subject image is converted to an electric signal by an image pickup element (CCD sensor) 31, based on light and shade, converted to a digital signal by an analog to digital converter 101, and input to a camera signal processing circuit 102.

The camera signal processing circuit 102 performs gamma correction, color signal separation or white balance adjustment for the taken image data converted to a digital signal by the analog to digital converter 101.

The taken image data output from the camera signal processing circuit 102 is supplied to the image display processing unit 104 through a memory controller 103. The image display processing unit 104 includes a video interface/on-screen-display (OSD) processing unit 105 and a video decoder 106, and generates an image signal for display output, that is, a video signal.

The output of the video decoder 106 is input to a liquid crystal panel driver (LCD Driver) 107, and displayed in an LCD panel 22 (hereinafter called an LCD) mounted in the frame 21 (refer to FIG. 1B).

The taken image data output from the camera signal processing circuit 102 is compressed in an image compression/expansion processing unit 108, when recording, and recorded in a main recording medium, for example, a hard disc unit 122 (HDD) or an attached removable recording medium, for example, a memory card 123, or a nonvolatile memory, through a media controller 121, under the control of a main control unit (CPU) 111. The image compression/expansion processing unit 108 compresses a still image by a known method such as JPEG, and a moving image (a non-still image) by MPEG. The memory card 123 may use a semiconductor memory called an SD card (registered trademark) and mini-SD (registered trademark). Namely, an optical disc may be used instead of the HDD 122.

When playing an image recorded in the HDD 122 or memory card 123, an image read from the HDD 122 or memory card 123 is expanded in the image compression/expansion processing unit 108, supplied to the image display processing unit 104 through the memory controller 103, and displayed in the LCD 22.

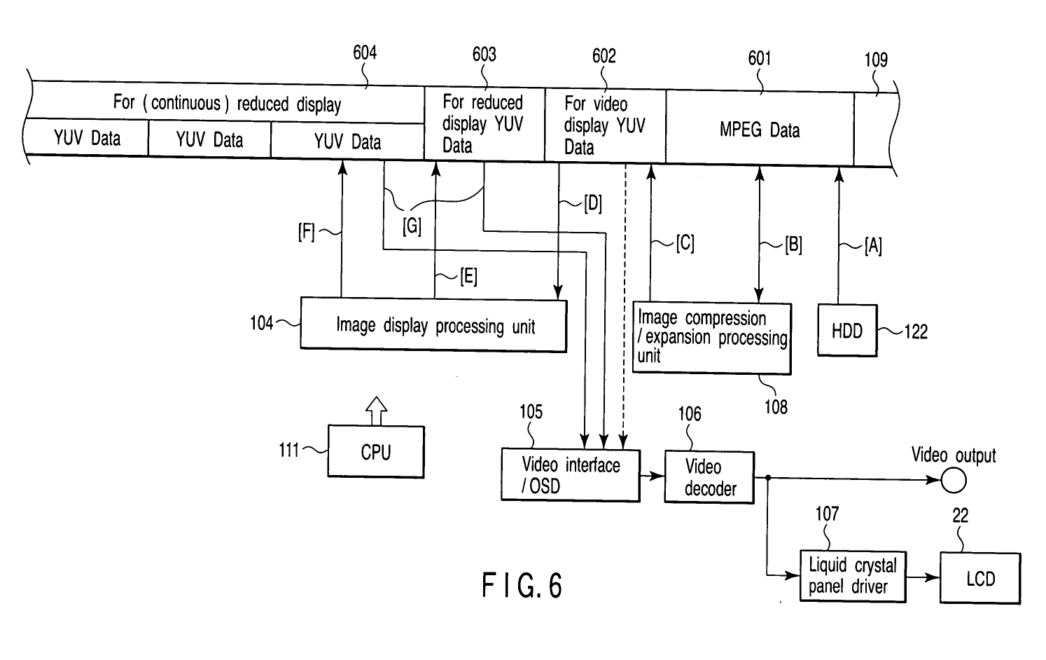

The image display processing unit 104 generates various images to be displayed in the LCD 22, for example, reduced images to be displayed as a list, by using a main memory (memory circuit, or SDRAM) 109 and buffer (work) memory 110 connected to the memory controller 103 (as explained in detail later with reference to FIG. 6). The generated reduced images are overlaid on an icon generated by the OSD 105 and various marks used to indicate operations, before displayed in the LCD 22. A part of the recording area of the main memory 109 may be assigned to the buffer (work) memory 110.

The main memory 109 and buffer memory 110 are used for reducing image data (generating a thumbnail image), editing in edit mode and changing the sequence of image file, though not explained in detail.

The buffer memory 110 can save image data for one screen or two or more screens. The image data saved in the buffer memory 110 is input to the image display processing unit 104 through the memory controller 103, and can be sequentially played (monitored) in the LCD 22 (the state of editing the image can be confirmed).

The camera apparatus 1 can capture voice/audio data through a microphone 132 connected to an Audio input/output processor 131 or an audio input terminal (Audio In), when editing or shooting. The audio data is correlated with the taken image data and recorded in a predetermined area of the HDD 122 or memory card 123.

The recorded audio data is read with the taken image data from the HDD 122 or memory card 123, and output to a speaker 133 or audio output terminal (Audio Out), when playing an image. Of course, voices output from the speaker 133 can be eliminated (the output level can be set to “0”) when playing an image.

In the HDD 122 as a recording medium, according to the capacity, the recordable number of still images or the time to record moving images (the number of titles) reaches several 100 to several 1000. Thus, a high speed is demanded to feed the recorded images or titles forward and backward.

Therefore, the jog dial 26 and OK button 27 permit selection of many images or titles and setting of operation modes without a stress. (An easy-to-use switch such as the jog dial 26 is useful when specifying an image by continuously searching many images or titles.) The contents input by the jog dial 26 (by the user's operation), operation states of the camera apparatus 1, or display of the menu screen by the menu button 29 are combined through the CPU 111, memory circuit 109, image display processing unit 104, video interface and OSD processor 105, and displayed in the LCD 22.

The OK (set) button 27 gives the CPU 111 information that the button 27 is pressed (on/off signal is input). Based on the on/off signal input from the information (the button 27), the CPU 111 determines the image/title or mode selected by the jog dial 26, and plays the image/title or sets the mode.

The jog dial 26 gives the CPU (main control unit) 111 information about the rotation angle and speed. The CPU 111 can control the (next) image display speed from the information.

The OK (set) button 27 is placed coaxially (concentrically) with the center of rotation of the job dial 26. The OK (set) button 27 can input the above-mentioned ON signal when pressed substantially toward the center (in the axial direction), and can input a control command (instruction) to scroll an image displayed in the LCD 22 in the pressed direction, when pressed in one of four directions (generally called “up/down/left/right”) dividing the circumference equally into four parts.

Explanation will now be given on the characteristic configuration and image data processing method in the camera apparatus of one embodiment of the invention.

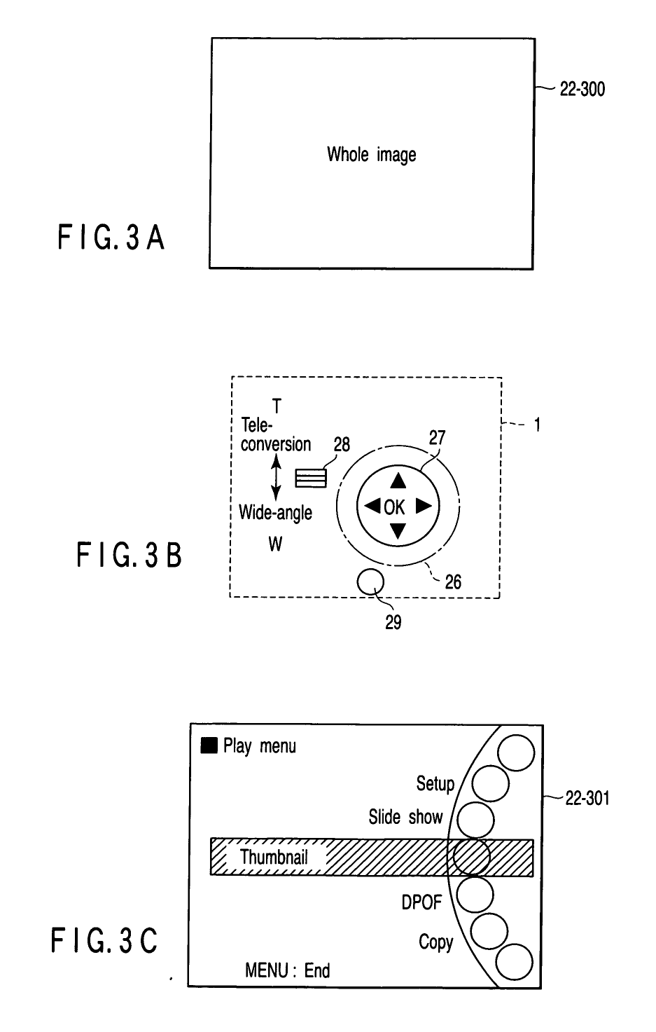

For example, when the menu button 29 of the camera apparatus 1 is turned on in the state that the whole image 22-300 of an object image (moving image) is displayed in the LCD 22 (extracted and explained in FIG. 3B) during playback of an image, as shown in FIG. 3A, the image displayed in the LCD 22 is switched to a play menu select/accept screen as shown in FIG. 3C.

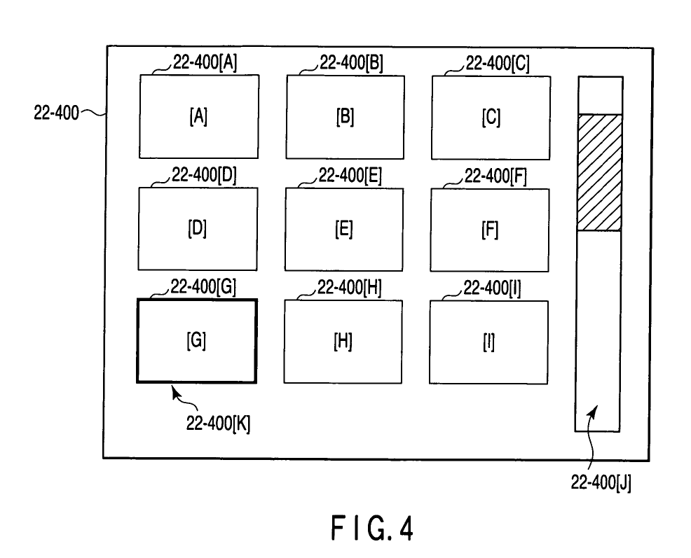

When “Thumbnail” is selected (displayed in reverse by the scroll) by the jog dial 26 on the menu screen and the OK button 27 is turned on, a thumbnail screen 22-400 displaying a list of reduced images is displayed as shown in FIG. 4. In the thumbnail screen, reduced images 22-400[A] to 22-400[I] are displayed with a scroll bar 22-400[J] which indicates the portion of the displayed reduced images in the whole image data recorded in the HDD 122 or memory card 123. A selector cursor 22-400[K] (image specify frame) generated by the OSD 105 is put on any one of the reduced images 22-400[A] to 22-400[I].

When nine (3×3) reduced images are displayed as shown in FIG. 4, the cursor 22-400[K] can be put on the image [E] displayed as the image 22-400[E] at the center, or the image [A] called a first image and displayed as the image 22-400[A], or the image [I] called an end image and displayed as the image 22-400[I], for example. For a moving image (non-still image), a not-shown mark “move”, for example, indicating a moving image is displayed.

When moving to one of the “up/down/left/right” directions is instructed (input) by the OK button 27, the selector cursor 22-400[K] is moved.

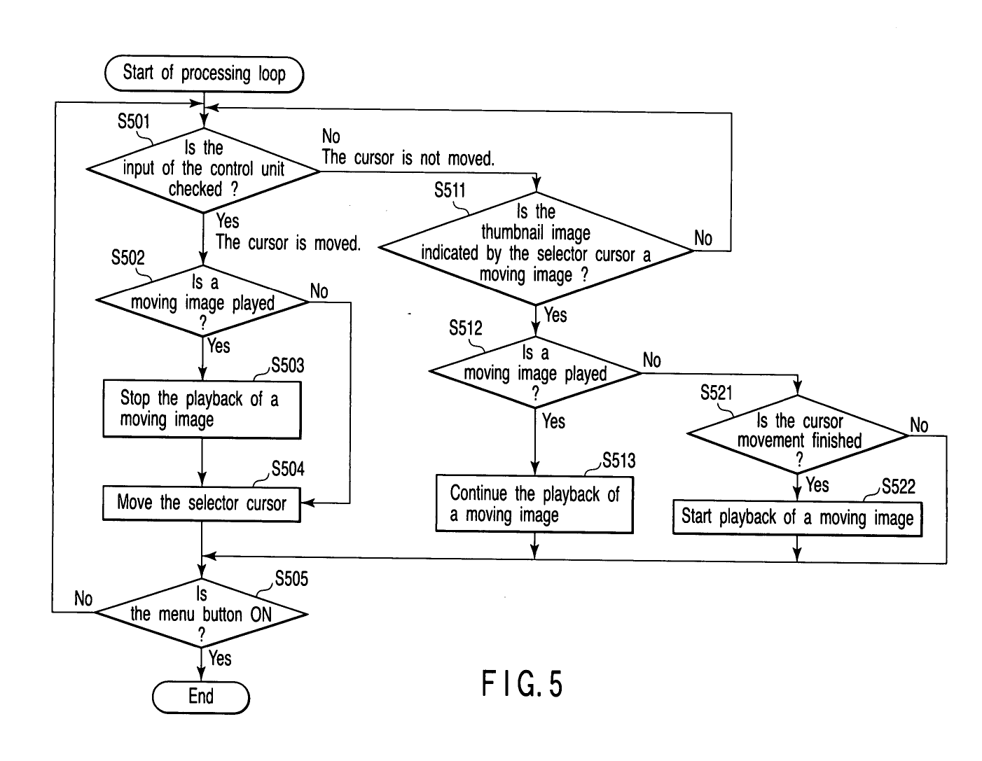

The reduced images 22-400[A] to 22-400[I] shown in FIG. 4 are displayed regardless of whether they are still or moving images. Therefore, when a moving image is displayed, it is usually a fist image in an image file. When an image overlaid with the cursor 22-400[K] is a moving image, the moving image can be displayed in a reduced state in the procedure explained later with reference to FIG. 5.

FIG. 5 is a flow chart of playing a reduced image as a moving image, when a reduced image selected from multiple reduced images is a moving image.

When changing to the menu screen is instructed through the menu button 29 extracted and explained in FIG. 3B and the thumbnail (display) is selected in the menu screen (FIG. 3C), a processing loop is started. Here, a continuous image consisting of an optional number of images taken within predetermined time is also expressed as a moving image.

When the CPU 111 monitors an input of instruction to move the selector cursor (22-400[K] in FIG. 4) by the OK button 27 (operation unit) (S501—Yes), whether a moving image is (now) being played is checked (S502).

When a moving image has been played in step S502 (S502—Yes), the playback of a moving image is stopped (S503) and the selector cursor is re-set to movable (S504).

Thereafter, when the menu button 29 is turned on, the display is returned to the menu screen (S505).

When a moving image is not played in step S502 (S502—No), the selector cursor is held in the movable state (the state capable of specifying an optional reduced image) (S504).

When an image selected by the selector cursor is a moving image, time is counted and when the cursor is mot moved for one second, the moving image is reduced and played within the cursor frame selected now.

When movement of the selector cursor is not instructed (the selector cursor is moved and stopped at an optional reduced image) (S501—No), whether the selected image (overlaid with the selector cursor) is a moving image is judged (S511), and if the image is a still image (not a moving image), the system waits for an input (S511—No).

When the image selected in step S511 is a moving image (S511—Yes), whether the moving image is played (S512), and if the moving image is being played (S512—Yes), the playback is continued (S513).

When the image selected in step S511 is a moving image (S511—Yes) and that image is not played (S512—No), whether movement of the selector cursor is instructed by the OK button 27 (control unit) is checked for a predetermined time (S512). For example, when movement of the selector cursor is not instructed for one second (S521—Yes), a reduced image (moving image) of the selected image is played (S522).

The check of the movement of the selector cursor for a predetermined time in step S521 is useful to have a certain decision time. Because, when a moving image is included in reduced images on which the selector cursor is moved (during the cursor movement), if a routine of playing a moving image is started whenever the cursor is moved, that operation becomes useless if a moving image is not selected.

Next, explanation will be given on the control system, which makes a moving image selected from the multiple reduced images shown in FIG. 5 playable.

Two or more images can be displayed by repeating this operation by the number of displaying images.

It is possible, for example, to receive the information of the operation switch input from the control unit in the CPU 111, and move the selector cursor according to the information. It is also possible to select one image to be played.

FIG. 6 shows the configuration and signal flow of displaying a selected moving image among the multiple reduced images shown in FIG. 5. The components already explained in FIG. 2 are given the same numerals, and detailed explanation will be omitted. The same components as those in FIGS. 1A and 1B are given the same numerals.

First, in label [A], a MPEG compressed playback streaming signal output from the HDD 122 (or the memory card 123) is transferred to a map 601 of the SDRAM (memory circuit) 109.

Then, in label [B] and label [C], the data is decoded in the image compression/expansion processing unit (MPEG codec) 108, and converted to a YUV signal for video display, and transferred to a map 602 of the SDRAM 109, as a YUV signal.

The YUV signal, when displayed without modifying, is given OSD (here, the data corresponding to the frame of the display 22-400[K] in FIG. 4) in the video interface and OSD processor 105, converted to a video signal by the video decoder 106, and displayed in the LCD 22 through the liquid crystal panel driver 107. When displaying in an externally connected display unit, a signal output to a video output (Video Out) terminal can be used.

The YUV signal is input to the image display processing unit 104 in order to generate YUV data used for displaying a selected image as a reduced moving image (label [D]).

The image display processing unit 104 is an engine used to magnify or reduce an image (for displaying still and moving images in a state that multiple still images are continued), and high-speed processing is possible. In addition, existing techniques, such as bi-linear or bi-cubic interpolation and filtering are possible to increase the image quality. Most of these techniques have been used originally for magnification and reduction of a still image.

In the image display processing unit 104, a file including multiple still images used for displaying a single reduced image or a reduced moving image is stored in maps 603 (label [E]) and 604 (label [F]) of the memory circuit 109.

Namely, displaying a moving image from a reduced image in this invention is performed by preparing reduced still images from an optional moving image, and sequentially transferring (outputting) them according to a transfer request, whenever requested. This is simple and low cost. With the recent high-speed (decreased processing speed) hardware structure (SDRAM), an image can be processed in real time if the size is standard. Data corresponding to a reduced image (a moving image or continuous images) displayed in the LCD 22 through the OSD processor 105, or a thumbnail image is sequentially moved to an image file to be selected when movement in the direction of “up/down/left/right” is instructed (input) from the OK button 27, and the corresponding reduced images are sequentially stored in the maps 603 (label [E]) and 604 (label [F]) of the SDRAM 109.

Thereafter, the still image prepared in the maps 603 (label [E]) and 604 (label [F]) of the main memory (SDRAM) 109 in the above process and the file label [F] including the multiple still images used for displaying a reduced moving image are overlaid through the video interface and OSD processor 105, and output to the video decoder 106 (label [G]).

Display (playback) of a moving image in a reduced state by the above-mentioned file including multiple still images used for displaying a reduced moving image utilizes the high-speed image data transfer with the SDRAM (memory circuit) 109, and can be easily realized by the above-mentioned simple method.

Trick plays, such as reverse playback, fast forward playback, step playback and slow playback are the processes before the data is stored in the YUV map for video display in the image display processing unit 104 of an embodiment of the present invention, and can be easily achieved by previously preparing for reverse playback, fast forward playback, step playback and slow playback correlated to multiple still images reduced from an optional moving image.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The embodiment of the invention is applicable also to a video camera using a tape as a recording medium, for example, without modifications. A camera may be a still camera for shooting (recording) a still image, using a large capacity memory card as a main recording medium, and an optional external recording medium as an auxiliary recording medium.

In a state that multiple images are displayed, when the displayed images include a moving image or a continuous image consisting of two or more continued images equivalent to a moving image, the moving image or continued images can be played while displaying the multiple images.

It is also possible to play only an image selected by a selector cursor without playing all displayed moving images or continuous images.

This eliminates a process of selecting a specific one screen and playing a corresponding image file, and improves retrievability.

As a moving image is played back from a reduced image, this is a simple and low cost method requiring no specific configuration.

What is claimed is:

1. A camera apparatus which displays multiple images by using a reduced image and is configured to select a desired image, comprising a function of playing continuously a moving image in a reduced state during playback of multiple images, when a moving image is included in the multiple images.

2. The camera apparatus according to claim 1, wherein when a selector cursor is put on the reduced imaged corresponding to the moving image during playback of the multiple images, or when a state that the selector cursor is put on the reduced image is continued for a predetermined time, the moving image corresponding to the reduced image is displayed.

3. The camera apparatus according to claim 1, further comprising:
a recording unit which holds an image file;
a display unit which displays a moving image of the image file held in the recording unit; and
an image display control unit which displays multiple reduced images including the moving image in the display unit.

4. The camera apparatus according to claim 2, further comprising:
a recording unit which holds an image file;
a display unit which displays a moving image of the image file held in the recording unit; and
an image display control unit which displays multiple reduced images including the moving image in the display unit.

5. The camera apparatus according to claim 3, wherein the image display control unit prepares multiple reduced images corresponding to the selected moving image, and transferring sequentially the multiple images to the display unit, whenever requested.

6. The camera apparatus according to claim 5, wherein the image display control unit prepares multiple reduced images corresponding to the selected moving image, and transferring sequentially the multiple images to the display unit, whenever requested.

7. A camera apparatus comprising:
a lens which takes recording information as changes of light;
an image signal generator which generates an image file of moving images corresponding to the information taken by the lens;
a recording unit which holds the image file;
a display unit which displays an optional image in the image file held in the recording unit;
an image display control unit which displays multiple reduced images in the display unit; and
a moving image display control unit which displays a moving image in a reduced state, when a moving image is included in the reduced images displayed in the display unit and playback of the moving image is selected.

8. The camera apparatus according to claim 7, wherein when a selector cursor is put on the reduced imaged corresponding to the moving image during playback of the multiple images, or when a state that the selector cursor is put on the reduced image is continued for a predetermined time, the moving image display control unit displays the moving image corresponding to the reduced image.

9. An image processing method comprising:
transferring a compressed playback streaming signal output from an image holding unit, to a map;
decoding the transferred playback streaming signal, converting to a YUV signal, and transferring to a map as a YUV signal;
generating continuous multiple reduced images from the YUV signal, and storing the images on the map; and
transferring the continuous multiple reduced images prepared on the map sequentially to a display unit, according to a playback request.
